(19) United States
(12) Patent Application Publication
(10) Pub. No.: US 2024/0152767 A1
(43) Pub. Date: May 9, 2024

(54) VISUAL QUESTION ANSWERING WITH UNLABELED IMAGE AUGMENTATION

(71) Applicant: NEC Laboratories America, Inc., Princeton, NJ (US)

(72) Inventors: Vijay Kumar Baikampady Gopalkrishna, Santa Clara, CA (US); Samuel Schulter, Long Island City, NY (US); Xiang Yu, Mountain View, CA (US); Zaid Khan, Cambridge, MA (US); Manmohan Chandraker, Santa Clara, CA (US)

(21) Appl. No.: 18/497,079

(22) Filed: Oct. 30, 2023

Related U.S. Application Data
(60) Provisional application No. 63/422,629, filed on Nov. 4, 2022.
(60) Provisional application No. 63/423,945, filed on Nov. 9, 2022.

(51) Int. Cl. G06N 3/096; G06N 3/006; G06N 3/047

(52) U.S. Cl. CPC G06N 3/096; G06N 3/006; G06N 3/047

(57) ABSTRACT

Systems and methods for training a visual question answer model include training a teacher model by performing image conditional visual question generation on a visual language model (VLM) and a targeted visual question answer dataset using images to generate question and answer pairs. Unlabeled images are pseudolabeled using the teacher model to decode synthetic question and answer pairs for the unlabeled images. The synthetic question and answer pairs for the unlabeled images are merged with real data from the targeted visual question answer dataset to generate a self-augmented training set. A student model is trained using the VLM and the self-augmented training set to return visual answers to text queries.

### RELATED APPLICATION INFORMATION

This application claims priority to U.S. Provisional Application No. 63/422,629, filed on Nov. 4, 2022, and U.S. Provisional Application No. 63/423,945, filed on Nov. 9, 2022, both incorporated herein by reference in their entirety.

### BACKGROUND

### Technical Field

The present invention relates to visual question answering (VQA) and more particularly to systems and methods for training visual answering models using unlabeled images.

### Description of the Related Art

Visual Question Answering (VQA) is a multimodal task where a model needs to answer a question based on an input image. VQA can be used in a wide variety of applications including object/scene/action/attribution recognition, counting, spatial reasoning, knowledge-based reasoning, common sense reasoning, and so on. A dominant paradigm for training a VQA model is to finetune a pre-trained foundational (vision-language model) model on a target VQA dataset. While the annotated datasets for natural images are moderately large containing a diverse set of question-answers pairs, the same for specialized VQA tasks such as knowledge-based VQA or VQA for other domains (e.g., medical, art, etc.) are often small containing fewer question-answer pairs. Training VQA models on a small target dataset can result in overfitting thereby reducing the robustness and the generalization performance. Collecting additional annotations for knowledge intensive tasks or specialized domains to expand a dataset is often prohibitively expensive.

### SUMMARY

According to an aspect of the present invention, a computer-implemented method for training a visual question answer model includes training a teacher model by performing image conditional visual question generation on a visual language model (VLM) and a targeted visual question answer dataset using images to generate question and answer pairs. Unlabeled images are pseudolabeled using the teacher model to decode synthetic question and answer pairs for the unlabeled images. The synthetic question and answer pairs for the unlabeled images are merged with real data from the targeted visual question answer dataset to generate a self-augmented training set. A student model is trained using the VLM and the self-augmented training set to return visual answers to text queries.

According to another aspect of the present invention, a system for training a visual question answer model includes a hardware processor and a memory that stores a computer program which, when executed by the hardware processor, causes the hardware processor to train a teacher model by performing image conditional visual question generation on a visual language model (VLM) and a targeted visual question answer dataset using images to generate question and answer pairs, pseudolabel unlabeled images using the teacher model to decode synthetic question and answer pairs for the unlabeled images, merge the synthetic question and answer pairs for the unlabeled images with real data from the targeted visual question answer dataset to generate a self-augmented training set and train a student model using the VLM and the self-augmented training set to return visual answers to text queries.

According to another aspect of the present invention, a computer program product for training a visual question answer model is provided. The computer program product includes a non-transitory computer readable storage medium having program instructions embodied therewith, the program instructions executable by a computer to cause the computer to perform a method including training a teacher model by performing image conditional visual question generation on a visual language model (VLM) and a targeted visual question answer dataset using images to generate question and answer pairs; pseudolabeling unlabeled images using the teacher model to decode synthetic question and answer pairs for the unlabeled images; merging the synthetic question and answer pairs for the unlabeled images with real data from the targeted visual question answer dataset to generate a self-augmented training set; and training a student model using the VLM and the self-augmented training set to return visual answers to text queries.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for training a visual question answer model, in accordance with an embodiment of the present invention;

FIG. 2 is a diagram illustrating question answer and image associations that can be employed in training, in accordance with an embodiment of the present invention;

FIG. 3 is a block/flow diagram illustrating a system/method for training a visual question answer model, in accordance with an embodiment of the present invention;

FIG. 3 is a block/flow diagram illustrating a system/method for training a visual question answer model, in accordance with an embodiment of the present invention;

FIG. 4 is a block diagram showing an exemplary processing system employed in accordance with an embodiment of the present invention;

FIG. 5 is a generalized illustrative diagram of a neural network, in accordance with an embodiment of the present invention;

FIG. 6 is a block diagram showing a medical system that employs a visual question answer model, in accordance with an embodiment of the present invention; and

FIG. 7 is a flow diagram illustrating a method for training a visual question answer model, in accordance with an embodiment of the present invention.

### DETAILED DESCRIPTION OF PREFERRED EMBODIMENTS

In accordance with embodiments of the present invention, systems and methods are provided that introduce a data augmentation technique for visual question answering (VQA) that generates additional training data in the form of synthetic question-answer pairs for images from a target VQA dataset and pseudo-labels (synthetic question-answer pairs) for unlabeled images (images without associated question-answer pairs) from the target VQA dataset. The generated data is combined with data (image+question-answer pairs) from the target VQA dataset to form a larger training set. The VQA models fine-tuned on this combined data can improve model robustness and generalization performance.

In useful embodiments, a pipeline for data augmentation for VQA training generates additional training data in the form of additional synthetic question-answer pairs for the images from the target dataset and new synthetic question-answer pairs for the unlabeled images from the target dataset. A technique to remove noisy synthetic question-answer pairs to improve the training set is also provided.

In one embodiment, synthetic question-answer pairs can be generated. A visual question generation (VQG) module is trained that employs an image as the input and question-answer pairs as the output. Once VQG is trained, it is used to generate pseudo-labels for unlabeled images from the target dataset.

Conventional visual question generation methods use annotations, such as ground truth answers or bounding boxes to be available. Therefore, existing visual question generation methods cannot easily take advantage of unlabeled images. Visual question generation methods are further constrained by the type of annotation they can take advantage of, for example, bounding-box based methods may not be applicable in a setting where there are very few object-centric questions and are further restricted by the closed-set assumption.

In classic self-training, such as for object detection, the task of generating pseudolabels is identical to the prediction task. In accordance with the present embodiments, generating pseudolabels (a question+answer pair conditional on an image) is a different task than prediction (generating an answer conditional on a question+image pair). Self-training uses labeled data to train a teacher model. The teacher model provides labels for auxiliary unlabeled data. A student model is then trained on the labeled data augmented with newly-labeled (pseudo-labeled) data. In the present embodiments, the task of the teacher (generate a question and answer for an image) is different than the task of the student (generate an answer for an image). Therefore, the student and teacher are trained to optimize different objectives.

In contrast to semi-supervised learning, a strategy in accordance with embodiments of the present invention does not require unlabeled images. The pseudolabels generated by this strategy are effective even when added to a completely annotated set of images, such as a complete VQA dataset. Similar to visual question generation, natural language augmentation cannot use unlabeled images, because it relies on the existence of labels (questions) for images, and often depends on a limited set of handcrafted rules. Furthermore, natural language augmentation is limited in the diversity of questions it can create, since every augmented question is a semantically identical variation of an existing question.

In useful embodiments, unlabeled images are exploited by generating new questions and answers. Domain generalization in VQA, which remains unexplored, is employed to improve processing speed and accuracy in VQA tasks.

Unlabeled images are cheap and often available. Unlabeled images can be exploited to generate new question+answer pairs for the unlabeled images, and use them during training when finetuning large autoregressive vision-language models on a target VQA task. The model itself can be employed to generate synthetic training data by directly labeling raw images with new questions and answers that are used to augment the existing training data. In contrast to existing approaches, no pretrained object detectors, handcrafted augmentation rules, bounding boxes, guidance, or captions for the unlabeled images are required. The present system learns to generate question and answer pairs matching the style and distribution of the target VQA task.

A large vision-language model can be harnessed for self-training. A three-stage framework is provided where in the first stage, a teacher model is trained by updating the weights of the model to generate questions and answers drawn from the same approximate distribution as the target VQA task. In the second stage, unlabeled images are provided to the teacher, and question-answer pairs are stochastically generated for the unlabeled images. In the third stage, a student model is trained by reverting the weights of the model back to the pretrained weights and finetuning them on the concatenation of synthetic and real question-answer pairs. The three-stage framework is based on self-training and pseudolabeling for exploiting unlabeled images when finetuning a large vision-language model on a target VQA task. The framework improves performance on VQA tasks in two different image domains and results in significant increases in robustness as measured by the inventors in at least three challenging VQA tests set for robustness. The framework further improves domain generalization from natural images to other domains. Improvements in 0-shot transfer and retention of numerical reasoning when transfer learning is also realized.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

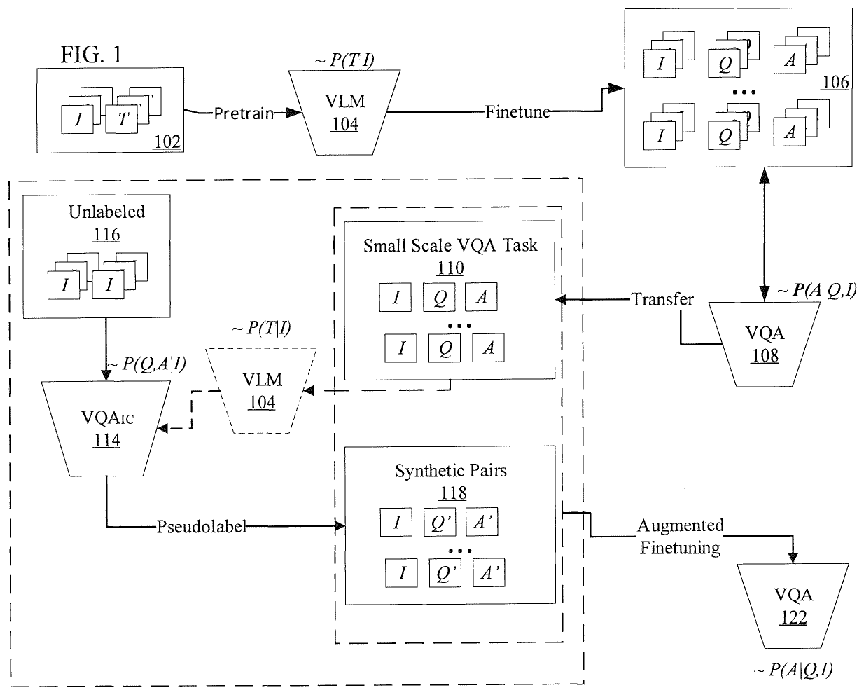

Referring now in detail to the figures in which like numerals represent the same or similar elements and initially to FIG. 1, a high-level system/method for training a visual question answering (VQA) model is illustratively depicted in accordance with one embodiment of the present invention. Web-scale pretraining of image and text pairs 102 endows large visual language models (VLMs) 104 with significant knowledge that small-scale VQA datasets can fail to adequately exploit, even when transfer learning, due to limited training data. VLM 104 is employed to generate and finetune image, question and answer associations in block 106. An updated VQA model 108 undergoes transfer learning to develop small-scale VQA tasks 110. VLM 104 is then self-improved with unlabeled images 116 by creating a teacher model (VQG_{IC}) 114 initialized from the large VLM 104 that generates questions and answers conditional on an image alone. Self-training on the small-scale dataset 110 augmented with pseudolabeled images which create synthetic pairs 118 from the teacher model (VQG_{IC}) 114 improves over finetuning purely on the small-scale dataset 110. A VQA model 122 is trained using the augmented dataset. Throughout the description and FIGS. the following abbreviations are employed. Q=question, A=answer, I=image. P(A|Q, I) is the conditional probability that A is in Q, I.

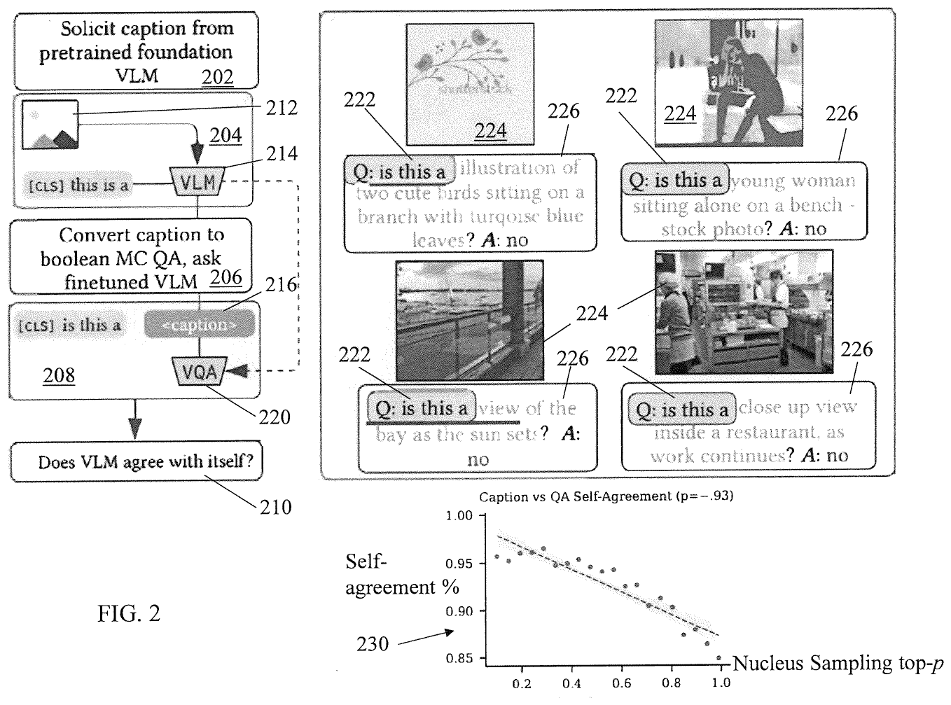

Referring to FIG. 2, in accordance with one embodiment, self-training is employed to train a VQA 122 (FIG. 1). A large VLM 214 contains dark knowledge that can be drawn out with stochastic decoding (e.g., nucleus sampling can be used). Captions are solicited from a pretrained foundation VLM in block 202. On a sample of, e.g., 1,000 images 212 from the VLM 214 can caption images with correct knowledge that it is unable to verify when posed as a VQA task. Even when decoding deterministically (e.g., beam search), the VLM 214 disagrees with itself on, e.g., 5% of images. Written prompts 222, associated with images 224 and VLM-written captions 226 are provided. Another data set (e.g., VQAv2) can be used for finetuning in block 206. Here, a caption 216 can be converted into a Boolean MC QA (modified Boolean for question+answer) and compared with VLM 214 for finetuning. In block 210, a determination is made as to whether the VLM agrees with itself. An inset panel 230 depicts how self-agreement decreases as diversity of the captions (the top-p parameter used in nucleus sampling) increases.

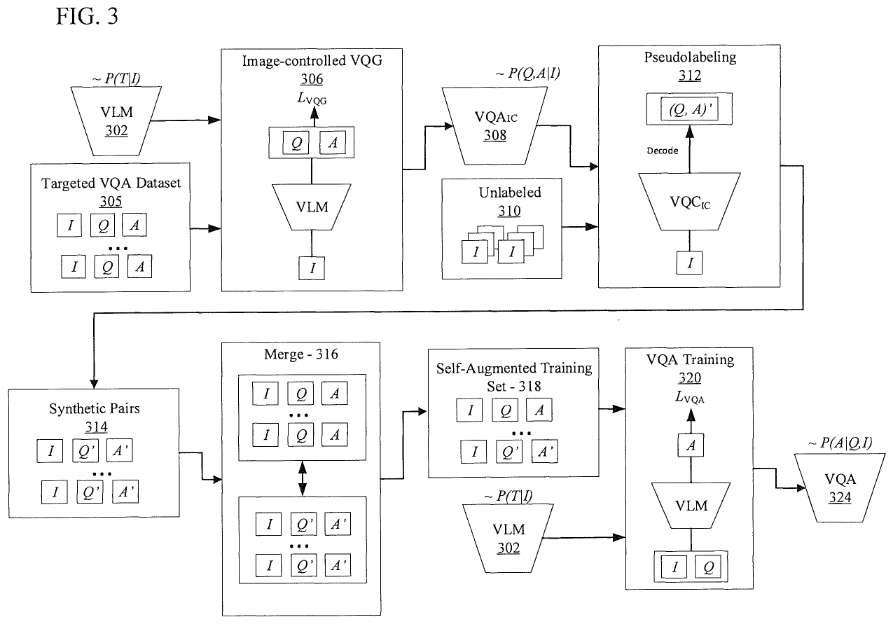

Referring to FIG. 3, a schematic diagram shows a framework in accordance with an embodiment of the present invention. In block 306, a teacher model VQG_{IC} 308 is trained using images and question answer pairs from a target dataset 305 and VLM 302. The teacher model 308 is image conditioned to associate question answer pairs with images (I) by optimizing a loss function (L_{VQG}). The updated teacher model 308 is then employed with unlabeled images 310 for pseudolabeling in block 312 on the unlabeled images (I) 310 alone to produce pseudolabels (by decoding questions and answers from the teach model 308) for the unlabeled images 310.

Synthetic pairs 314 are created by associating the unlabeled images 310 with pseudolabeled questions and answers (Q′, A′). The synthetic pairs 314 are employed as additional training data to improve accuracy. In block 316, the targeted data set 305 and the synthetic pairs 314 are merged to provide a self-augmented training set 318. A student VQA model 324 is then trained in block 320 on real training samples from VLM 302 augmented with the pseudolabeled images from the self-augmented training set 318. Training can include inputting images with questions and minimizing a loss function (L_{VQA}) on answers.

In one embodiment, a goal is to pseudolabel unlabeled images in block 312 with generated questions and answers using the teacher model 308, and then train the student model 324 on the real VQA pairs augmented with the generated VQA pairs in the self-augmented training set 318. To generate the pseudolabels, the visual question generation (VQG_{IC}) model 308 is trained on the real question-answer pairs and images as the teacher. This teacher model VQG_{IC} 308 highlights the image-conditional nature of the model, because the model generates both a question and answer conditioned on an image alone. The teacher model 308 is then fed unlabeled images 310 and stochastically decodes from the teacher model 308 to generate pseudolabels, which are parsed into question answer pairs in block 312. After the real samples in the dataset have been augmented with the self-generated samples, VQA training can proceed. The approach employed is preferably compatible with any encoder-decoder multimodal architecture. This is because the approach can rely on direct image-to-text generation, which is possible in large vision language models (VLMs) since their autoregressive decoders are designed to be conditioned on an image.

In block 306, direct image-conditional VQG training can include self-training. Self-training needs a teacher model to produce pseudolabels that the student model then learns to mimic. To use unlabeled data for VQA 324, the teacher model 308 needs to be able to pose a question and provide an answer given an unlabeled image, which is a different task from VQA processing. Given an image I, a question Q and answer A, the VQA student 324 needs to approximate P(A|Q, I), while the teacher model 308 needs to approximate P(Q, A|I). Conventional approaches to visual question generation (VQG) cannot work with unlabeled data because they approximate P(Q|I, A), that is, they generate a question conditional on the image and a potential answer. In contrast to this and in accordance with embodiments of the present invention, an image conditional (IC) approach (VQG_{IC}) has been developed and employed by the teacher model 308.

To create the VQG_{IC} teacher model 308 that approximates P(Q, A|I), the problem of learning such a model is treated as a text-generation problem, and the autoregressive decoder of the vision-language model is trained to approximate P(T|I), where T=(Q, A). Let D_{QA} be a question answer dataset to create a teacher model from. For a sample (Q, A, I)∈D_{QA}, the sample is transformed into a target sequence of tokens T (y₁, y₂, . . . yₙ) by entering (Q, A) into a structured template of having the following form:
question: <question>?answer:<answer> (1), where <question> and <answer> are replaced by the content of Q and A, respectively.

Once T (y₁, y₂, . . . yₙ) is obtained, the teacher model (VQG) 308 is trained by optimizing:
L_{VQG}=Σₙ₌₁^{N} log P_{θ}(yₙ|y_{<n},x) (2) over all of the question-image-answer pairs in D_{QA}, where x represents the latent encoded features in the standard encoder-decoder architecture. The teacher model VQG_{IC} 308 thus learns through deep learning neural networks to maximize the conditional likelihood of a question-answer pair represented as a unified string, given an image in block 306.

Once the teacher model VQG_{IC} 308 has been obtained, self-training with unlabeled data 310 can proceed. To produce a pseudolabel (Q′, A′) for an unlabeled image Iᵤ, L_{I:N}=VQG_{IC}(Iu) is obtained, where L_{I:N} are the logits of the decoder. The logits L_{I:N} define a distribution P(L_{I:N}|L_{I:N-1}) over tokens of the model's natural language vocabulary. Nucleus sampling can then be applied to stochastically decode a text T′ from P(L_{I:N}|L_{I:N-1}). To recover a pseudo-question-answer pair (Q′, A′) from the decoded text T, the structured format of the generation template in equation (1) is exploited to recover the generated question and answer (Q′, A′).

Pseudolabeling a desired number of images can commence. Any number of triplets of the form (Q′, A′, Iᵤ) representing self-generated training data D′_{QA} in the style of a target dataset D_{QA} can be obtained. The real dataset D_{QA} is then augmented with the self-generated question answer pairs on unlabeled images D′_{QA} to create a self-augmented training dataset 318 D_{AugQA}=D′_{QA}∪D_{QA}. The teacher model 308 is no longer needed, and the student model 324 can be initialized from the checkpoint obtained after large-scale pretraining that the teacher model 308 was initialized from. At this point, VQA training can proceed. A training procedure can be employed where VQA is treated as an open-ended generation task, and the VQA (L_{VQA}) loss can be expressed as:
L_{VQA}=−Σₙ₌₁^{N} log P_{θ}(yₙ|y_{<n}, xₙ) (3), where xₙ is the n-th element of the multimodal sequence embeddings X_{I:N} produced by the composition D(E(Q,0 I)), where D is the multimodal decoder, E is the multimodal encoder, and Q, I is the question and image.

Embodiments of the present invention were tested in experiments. Self-taught data augmentation improves performance. This performance improvement holds even when, e.g., 447 k real pairs from VQAv2 are used for transfer learning, showing that self-taught data augmentation offers real improvements over manual annotations. On fine art VQA, self-taught data augmentation improves overall performance, with a large increase for visually grounded questions. For example, self-taught data augmentation induces at least a 2.1% performance improvement relative to a baseline model. Across all domains, self-taught data augmentation improves domain generalization over the baseline model. The improvement is greatest on fine art images, as the fine art domain is closest to the natural image domain with respect to the images, questions, and answers.

The self-training framework for finetuning large vision-language models on small-scale visual question answering tasks includes a teacher model, which is a visual question generation (VQG) model that can generate questions and answers from unlabeled images using the knowledge in the large vision-language model, in contrast to existing VQG approaches that require ground-truth annotations to generate question and answers from an image. This allows us to extend the paradigm of self-training with unlabeled images to visual question answering. By augmenting the manually annotated pairs in the small-scale dataset with the self-generated pairs obtained from the unlabeled images, a student model is trained that can be employed in many applications where visual information is helpful in response to text questions. These applications can include educational environments, medical environments, browsing environments and many others.

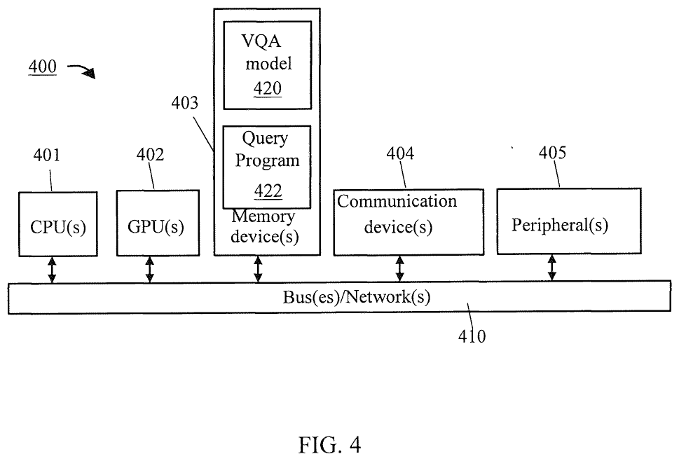

Referring to FIG. 4, a block diagram showing an exemplary processing system 400 employed in accordance with an embodiment of the present invention. The processing system 400 can include one or more computer processing units (e.g., CPUs) 401, one or more graphical processing units (GPUs) 402, one or more memory devices 403, communication devices 404, and peripherals 405. The CPUs 401 can be single or multi-core CPUs. The GPUs 402 can be single or multi-core GPUs. The CPUs and/or GPUs can be, in whole or part, hardware processing subsystems. The one or more memory devices 403 can include caches, RAMs, ROMs, and other memories (flash, optical, magnetic, etc.). The communication devices 404 can include wireless and/or wired communication devices (e.g., network (e.g., WIFI, etc.) adapters, etc.). The peripherals 405 can include a display device, a user input device, a printer, an imaging device, and so forth. Elements of processing system 400 are connected by one or more buses or networks (collectively denoted by reference numeral 410).

In an embodiment, memory devices 403 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 403 store program code for implementing visual question and answer queries using deep learning. A VGA model 720 can be stored in memory 703 along with program code 722 for generating a user interface and responding to queries with visual and textual information.

The processing system 700 may also include other elements (not shown), for example, various other input devices and/or output devices can be included in processing system 700, depending upon the particular implementation. Wireless and/or wired input and/or output devices can be employed. Moreover, additional processors, controllers, memories, and so forth, in various configurations can also be utilized. These and other variations of the processing system 700 can also be provided.

Moreover, it is to be appreciated that various figures as described below with respect to various elements and steps relating to the present invention that may be implemented, in whole or in part, by one or more of the elements of system 700.

A VQA model is trained to handle inferences in an information processing system. The VQA model includes an information processing structure, which includes a large number of highly interconnected processing elements (called “neurons” or “nodes”) working in parallel to solve specific problems. VQA models are trained using a set of training data, with learning that involves adjustments to weights that exist between the neurons. Here, the VQA model is configured for a specific application, such as responding to queries with visual images and/or text, through such a learning process.

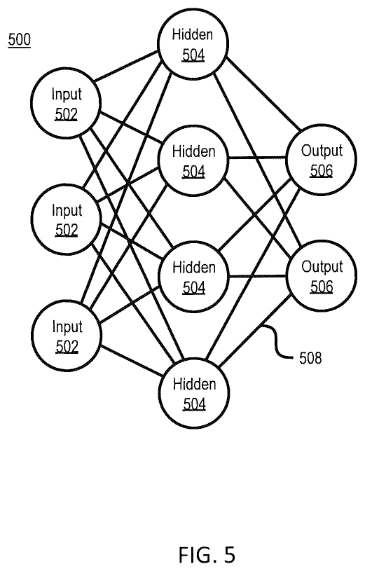

Referring now to FIG. 5, an illustrative diagram of a neural network 500 is shown. Although a specific structure is shown, having three layers and a set number of fully connected neurons, it should be understood that this is intended solely for the purpose of illustration. In practice, the present embodiments may take any appropriate form, including any number of layers and any pattern or patterns of connections therebetween.

VQA models demonstrate an ability to derive meaning from complicated or imprecise data and can be used to extract patterns and detect trends that are too complex to be detected by humans or other computer-based systems. The structure of a neural network is known generally to have input neurons 502 that provide information to one or more “hidden” neurons 504. Connections 508 between the input neurons 502 and hidden neurons 504 are weighted, and these weighted inputs are then processed by the hidden neurons 504 according to some function in the hidden neurons 504. There can be any number of layers of hidden neurons 504, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons 506 accepts and processes weighted input from the last set of hidden neurons 504.

This represents a “feed-forward” computation, where information propagates from input neurons 502 to the output neurons 506. Upon completion of a feed-forward computation, the output is compared to a desired output available from training data. The error relative to the training data is then processed in “backpropagation” computation, where the hidden neurons 504 and input neurons 502 receive information regarding the error propagating backward from the output neurons 506. Once the backward error propagation has been completed, weight updates are performed, with the weighted connections 508 being updated to account for the received error. It should be noted that the three modes of operation, feed forward, back propagation, and weight update, do not overlap with one another. This represents just one variety of computation, and that any appropriate form of computation may be used instead.

To train the VQA model, training data can be divided into a training set and a testing set. The training data includes pairs of an input and a known output (images and question and answers). During training, the inputs of the training set are fed into the VQA model using feed-forward propagation. After each input, the output of the VQA model is compared to the respective known output. Discrepancies between the output and the known output that are associated with that particular input are used to generate an error value, which may be backpropagated through the VQA model, after which the weight values of the VQA model may be updated. This process continues until the pairs in the training set are exhausted.

After the training has been completed, the VQA model may be tested against the testing set, to ensure that the training has not resulted in overfitting. If the VQA model can generalize to new inputs, beyond those which it was already trained on, then it is ready for use. If the VQA model does not accurately reproduce the known outputs of the testing set, then additional training data may be needed, or hyperparameters of the VQA model may need to be adjusted.

VQA model may be implemented in software, hardware, or a combination of the two. For example, each weight 508 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

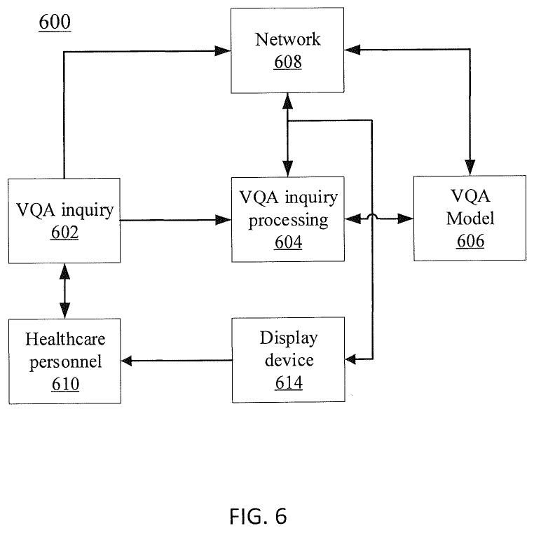

Referring now to FIG. 6, a system/method 600 for responding to medical inquiries using visual and textual information is illustratively depicted in accordance with an embodiment of the present invention. Medical personnel often require information in real-time while examining a patient or during a procedure. In many instances textual responses are inadequate. To improve decision making and to provide more accurate information, visual responses including images, videos and textual information provide a better and more complete response. In accordance with embodiments of the present invention, information made available to medical personnel/healthcare workers can include visual images and videos, which are provided using artificial intelligence systems.

In one embodiment, healthcare personnel 610 can generate a VQA query 602 using natural language or text and images. The query 602 can include, e.g., a question such as an image of a wound or lesion, an image of a rash or an MRI, CT scan, Xray, etc. The query 602 can be forwarded to a VQA query processing system 604 directly or through a network 608.

The VQA query processing system 604 can access, directly or through the network 608, a VQA model 606. The VQA model 606 includes a student model trained using self-augmented training data as described in accordance with embodiments of the present invention. The VQA model 606 along with the VQA processing system 604 uses neural networks to predict a best answer to the query using visual question answering (VQA) information. With the training methods as applied herein, the VQA model 606 can provide more accurate responses than conventional models. The response(s) generated can then be forwarded to the healthcare personnel 610 and are rendered on a peripheral device 612, such as a display device and/or speaker. For example, text, images or video can be displayed for the healthcare personnel 610, as appropriate. The healthcare personnel 610 can also use this information to update patient data and use this information to assist in decision-making for medical personnel. For example, the system 600 can assist in diagnosis of a condition by responding to image queries with an answer by providing graphical data or images in the response.

The network 608 can interact with any piece of the system and convey information and resources as needed to provide VGA responses. Information can be conveyed over the network 608 so that the information is available to all users. The functionality provided for determining VGA response can be provided as a service for medical staff and programmers to update patient's profiles or provide real-time information to healthcare personnel 610 in a distributed network setting, in a hospital setting, in a medical office setting, etc. The healthcare personnel 610 can employ the VQA response(s) to make better informed decisions, to refresh their memory on a procedure, educate a patient, etc.

In other embodiments, system/method 600 can be adapted for use in an educational or browsing environment. The VQA student model or model 606 can be trained in specific areas or subjects to assist, e.g., students in answering queries with visual responses.

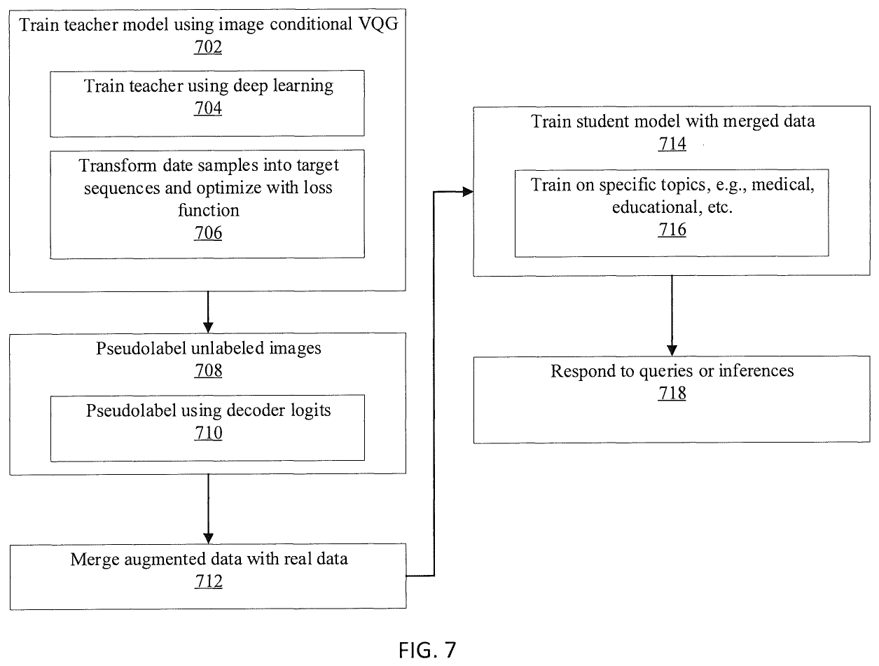

Referring to FIG. 7, a computer-implemented method for training a visual question answer model is described in accordance with an embodiment. In block 702, a teacher model is trained by performing image conditional visual question generation on a visual language model (VLM) and a targeted visual question answer dataset using images to generate question and answer pairs. In block 704, the teacher model can be trained using deep learning to maximize a conditional likelihood of a question-answer pair, given an image. In block 706, the targeted visual question answer dataset is generated by transforming data samples into a target sequence of tokens T (y₁, y₂, . . . yₙ) by entering (Q, A) into a structured template, where Q is a question, A is an answer; and optimizing a loss over all question-image-answer pairs.

In block 708, unlabeled images are pseudolabeled using the teacher model to decode synthetic question and answer pairs for the unlabeled images. In block 710, pseudolabels are produced for unlabeled images Lᵤ by obtaining logits of a decoder, and the logits define a distribution over tokens of the teacher model's natural language vocabulary.

In block 712, the synthetic question and answer pairs for the unlabeled images are merged with real data from the targeted visual question answer dataset to generate a self-augmented training set. In block 714, a student model is trained using the VLM and the self-augmented training set to return visual answers to text queries. The student model is trained to approximate P(T|I), where T=(Q, A), Q is a question, A is an answer and P(T|I) is the conditional probability of T in image I. Given an image I, a question Q and answer A, the student model approximates P(A|Q, I), while the teacher model approximates P(Q, A|I), where P(A|Q, I) is the conditional probability of A in Q, I and P(A, Q|I) is the conditional probability of A and Q in I to enable using unlabeled data in training.

In block 716, the student model is trained on specific images and information. In block 718, the student model is employed to respond to inquiries or inferences with visual answers within a specific subject matter. In one embodiment, the student model is trained on medical images and information and responds to medical inquiries with visual answers to assist in decision making for medical personnel. In other embodiments, the student model is trained on educational subjects including images and information and responds to inquiries with visual answers on these subjects.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a visual question answer model, comprising:
training a teacher model by performing image conditional visual question generation on a visual language model (VLM) and a targeted visual question answer dataset using images to generate question and answer pairs;
pseudolabeling unlabeled images using the teacher model to decode synthetic question and answer pairs for the unlabeled images;
merging the synthetic question and answer pairs for the unlabeled images with real data from the targeted visual question answer dataset to generate a self-augmented training set; and
training a student model using the VLM and the self-augmented training set to return visual answers to text queries.

2. The method as recited in claim 1, wherein training the student model includes training the student model to approximate P(T|I), where T=(Q, A), Q is a question, A is an answer and P(T|I) is conditional probability of T in image I.

3. The method as recited in claim 2, wherein the targeted visual question answer dataset is generated by transforming data samples into a target sequence of tokens T (y₁, y₂, . . . yₙ) by entering (Q, A) into a structured template, where Q is a question, A is an answer; and optimizing a loss over all question-image-answer pairs.

4. The method as recited in claim 1, wherein training the teacher model includes learning through deep learning to maximize a conditional likelihood of a question-answer pair, given an image.

5. The method as recited in claim 1, wherein pseudolabeling unlabeled images includes producing pseudolabels for unlabeled images Iᵤ by obtaining logits of a decoder, and the logits defining a distribution over tokens of a natural language vocabulary of the teacher model.

6. The method as recited in claim 1, wherein, given an image I, a question Q and answer A, the student model approximates P(A|Q, I), while the teacher model approximates P(Q, A|I), where P(A|Q, I) is conditional probability of A in Q, I and P(A, Q|I) is conditional probability of A and Q in I to enable using unlabeled data in training.

7. The method as recited in claim 1, wherein the student model is trained on medical images and information and further comprises responding to medical inquiries with visual answers to assist in decision making for medical personnel.

8. A system for training a visual question answer model, comprising:
a hardware processor; and
a memory that stores a computer program which, when executed by the hardware processor, causes the hardware processor to:
train a teacher model by performing image conditional visual question generation on a visual language model (VLM) and a targeted visual question answer dataset using images to generate question and answer pairs;
pseudolabel unlabeled images using the teacher model to decode synthetic question and answer pairs for the unlabeled images;
merge the synthetic question and answer pairs for the unlabeled images with real data from the targeted visual question answer dataset to generate a self-augmented training set; and
train a student model using the VLM and the self-augmented training set to return visual answers to text queries.

9. The system as recited in claim 8, wherein the computer program causes the hardware processor to train the student model to approximate P(T|I), where T=(Q, A), Q is a question, A is an answer and P(T|I) is conditional probability of T in image I.

10. The system as recited in claim 9, wherein the computer program causes the hardware processor to generate the targeted visual question answer dataset by transforming data samples into a target sequence of tokens T (y₁, y₂, . . . yₙ) by entering (Q, A) into a structured template, where Q is a question, A is an answer; and optimizing a loss over all question-image-answer pairs.

11. The system as recited in claim 8, wherein the computer program causes the hardware processor to train the teacher model by learning through deep learning to maximize a conditional likelihood of a question-answer pair, given an image.

12. The system as recited in claim 8, wherein the computer program causes the hardware processor to pseudolabel unlabeled images Iᵤ by obtaining logits of a decoder, and the logits defining a distribution over tokens of a natural language vocabulary of the teacher model.

13. The system as recited in claim 8, wherein, given an image I, a question Q and answer A, the student model approximates P(A|Q, I), while the teacher model approximates P(Q, A|I), where P(A|Q, I) is conditional probability of A in Q, I and P(A, Q|I) is conditional probability of A and Q in I to enable using unlabeled data in training.

14. The system as recited in claim 8, wherein the student model is trained on medical images and information and the computer program causes the hardware processor to respond to medical inquiries with visual answers to assist medical personnel.

15. The system as recited in claim 14, wherein the computer program causes the hardware processor to display visual responses on a display device.

16. A computer program product for training a visual question answer model, the computer program product comprising a non-transitory computer readable storage medium having program instructions embodied therewith, the program instructions executable by a computer to cause the computer to perform a method comprising:
training a teacher model by performing image conditional visual question generation on a visual language model (VLM) and a targeted visual question answer dataset using images to generate question and answer pairs;
pseudolabeling unlabeled images using the teacher model to decode synthetic question and answer pairs for the unlabeled images;
merging the synthetic question and answer pairs for the unlabeled images with real data from the targeted visual question answer dataset to generate a self-augmented training set; and
training a student model using the VLM and the self-augmented training set to return visual answers to text queries.

17. The computer program product as recited in claim 16, wherein training the student model includes training the student model to approximate P(T|I), where T=(Q, A), Q is a question, A is an answer and P(T|I) is conditional probability of T in image I.

18. The computer program product as recited in claim 16, wherein training the teacher model includes learning through deep learning to maximize a conditional likelihood of a question-answer pair, given an image.

19. The computer program product as recited in claim 16, wherein, given an image I, a question Q and answer A, the student model approximates P(A|Q, I), while the teacher model approximates P(Q, A|I), where P(A|Q, I) is conditional probability of A in Q, I and P(A, Q|I) is conditional probability of A and Q in I to enable using unlabeled data in training.

20. The computer program product as recited in claim 16, wherein the student model is trained on medical images and information and further comprising responding to medical inquiries with visual answers assist in decision making for medical personnel.
